(19) United States
(12) Patent Application Publication
(10) Pub. No.: US 2006/0044148 A1
(43) Pub. Date: Mar. 2, 2006

(54) On-demand system for connector access independent of ambient light level

(75) Inventors: Fonda J. Daniels, Cary, NC (US); Timothy Earl Figgins, Raleigh, NC (US); David Bruce Kumhyr, Austin, TX (US); Ruthie D. Lyle, Durham, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 10/933,171

(22) Filed: Sep. 2, 2004

(51) Int. Cl. G08B 21/00; H01R 3/00; G08B 13/14; G08B 5/22

(52) U.S. Cl. 340/686.1; 340/825.49; 340/572.1; 439/488

(57) ABSTRACT

A computer system includes a plurality of LEDs situated in correspondence to a plurality of connectors. System peripherals which connect to the plurality of connectors are outfitted to include a transponder having a unique RF ID tag The system further includes an RFID reader which detects an RF ID tag emitted by a proximate transponder when a user proceeds to plug-in a system peripheral outfitted with such transponder. The system further includes a light controller which selectively energizes the LEDs and provides a distinguishing energization signal to at least one but less than all of the LEDs based on the RF ID value. Preferably, the system processor oversees the selection.

### BACKGROUND OF THE INVENTION

This invention pertains to computer systems and other information handling systems and, more particularly, to a computer system in which illumination is provided to particular connectors depending on the type of peripheral to be engaged.

Laptops have become increasingly preferred over desktop systems because they allow users to engage in computing while maintaining mobility. It is not uncommon for computer users to engage in computing activity during their commute; for example, on the subway, in the airport, on an airplane, or even in one's backyard.

With increased use of mobility and diverse work environments, use of a laptop in changing ambient lighting conditions can be a challenge. A user may experience a temporary change in ambient light while riding a subway that passes through a tunnel, or in an airplane when the cabin lights are dimmed, or even in a building that experiences a temporary blackout as in the case of a sudden storm. Users have found it challenging to plug-in cables during decreased ambient light conditions. The reduced light levels make it difficult to see the rear side of the computer system where the connectors are located. Not only do users find it difficult to properly orient the cable's mating connector so that it will effortlessly slide into the connector on the system, users also find it difficult to identify which of the many system connectors is the appropriate connector.

These problems and challenges, however, are not limited to laptops. Users of desktop systems encounter similar challenges when the desktop computer system is located under a desk where dim lighting is usually encountered. Typically, a desktop computer system has a plethora of cables already attached and in many cases the system cannot be pulled out into the center of the room where lighting is more favorable. As a result, users may have to crawl under a desk and reach around in an attempt to identify the proper connector and orientation for the connector plug. Many times, if a user is not familiar with computer equipment, the user may have only a vague idea as to which plug mates with which connector. However, even an experienced user may have a difficult time identifying a connector and the proper orientation for the plug. For example, in dim lighting, even an experienced user may find it difficult to distinguish between a LAN connector and a modem connector.

### SUMMARY OF THE INVENTION

What is needed, therefore, is an apparatus and method which provides on-demand lighting. Furthermore, what is needed is an apparatus and method which provides distinguishing lighting in response to a users attempt to plug-in cables (power, USB, other peripherals).

As will be seen, the embodiments disclosed satisfy the foregoing needs and accomplish additional objectives.

It has been discovered that the aforementioned challenges are addressed using a system, program product, and method which includes or utilizes a plurality of light sources each situated in correspondence to a corresponding one of a plurality of connectors. System peripherals are provided which are intended to couple to the plurality of connectors. These provided peripherals are equipped to include a transponder having an identifiable ID tag. The system further includes an wireless ID controller which detects an ID tag emitted by a proximate transponder as in for example when a user proceeds to plug-in a system peripheral outfitted with such transponder. The system further includes a light controller which selectively energizes the plurality of light sources and provides a distinguishing energization signal to at least one but less than all of the light sources based on the ID tag value.

In one embodiment, the distinguishing energization signal is effective to energize at least one light source while a remainder of light sources are turned off. In other embodiments, a remainder of light sources which are other than the at least one light source are energized and the distinguishing energization signal provided to the at least one source is a flashing signal or a signal which causes light emission of a distinguishing color from the remainder of light sources.

In one embodiment, a processor is coupled to an RF ID controller and to an LED controller and receives a detected RF ID tag from the RF ID controller and passes control commands to the LED controller for selecting which LEDs to energize. The processor makes the selection by accessing a set of relational data tables which correlates RF ID tag values to specific ones of a plurality of LEDs. Selection of LEDs is carried out as a function of the relational data and the value of the received RF ID tag, wherein at least one but less than all of the plurality of LEDs are selected for energization.

### BRIEF DESCRIPTION OF THE DRAWINGS

Some of the purposes of the invention having been stated, others will appear as the description proceeds, when taken in connection with the accompanying drawings, in which:

FIG. 1 is a perspective view of the personal laptop computer of an embodiment of the present invention in an opened posture;

FIG. 2 is a schematic block diagram of the computer system shown in FIG. 1 according to a preferred embodiment of the present invention incorporating resources which enable an enhanced connectivity experience for its users;

FIG. 3 is a rear elevation view of the personal laptop computer of the preferred embodiment of the present invention;

FIG. 4 is table of relational data used in accordance with a preferred embodiment of the present invention for correlating LEDs to connector types;

FIG. 5 is a table of relational data used in accordance with a preferred embodiment of the present invention for correlating device ID's to connector requirements;

FIG. 6 is a flow diagram showing the logic for controlling I/O connector lighting according to a preferred embodiment of the present invention; and

FIG. 7 is a flow diagram showing the logic for controlling I/O connector lighting according to a preferred embodiment of the present invention.

### DETAILED DESCRIPTION OF THE ILLUSTRATIVE EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

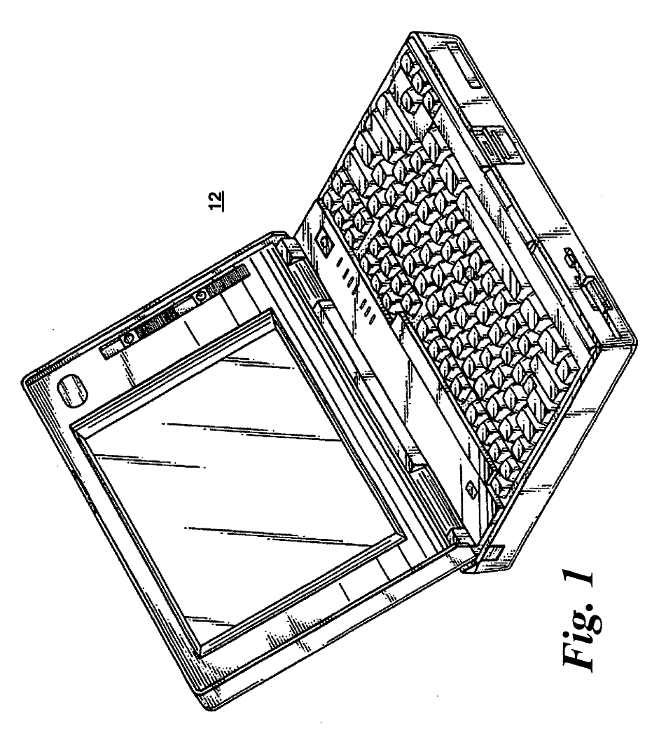

Referring now more particularly to the accompanying drawings, in which like numerals indicate like elements or steps throughout the several views, FIG. 1 is a perspective view of the personal laptop computer of a preferred embodiment of the present invention in an opened posture. While a laptop computer is shown in the specific sample herein, the inventive concepts described herein apply to desktop systems, servers, and any other type of system having a variety of I/O connectors or other connectors located in the back or in other parts of the system or other device.

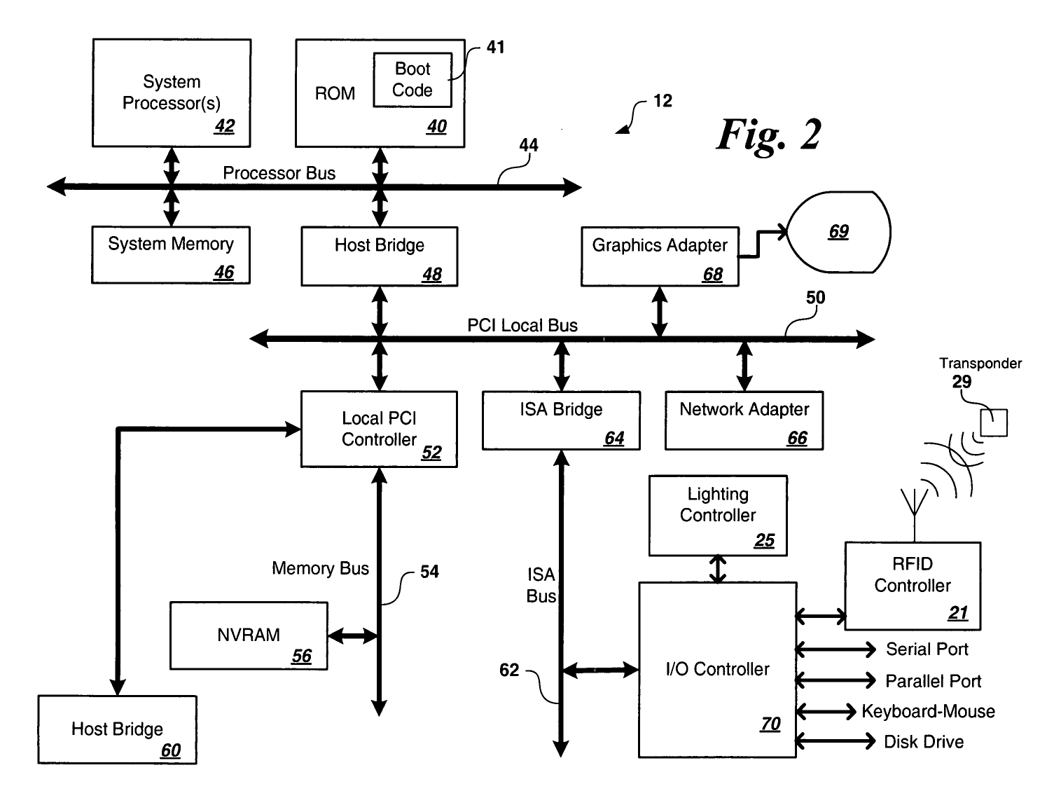

FIG. 2 is a schematic block diagram of the computer system 12 shown in FIG. 1 according to a preferred embodiment of the present invention incorporating resources which enable an enhanced connectivity experience for its users. The illustrative embodiment depicted in FIG. 2 is a ThinkPad® series personal laptop computer which is sold by International Business Machines (IBM) Corporation of Armonk, N.Y.; however, as will become apparent from the following description, embodiments of the present invention are applicable to ease of connectability for any data processing system.

As shown in FIG. 2, computer system 12 includes at least one system processor 42, which is coupled to a Read-Only Memory (ROM) 40 and a system memory 46 by a processor bus 44. System processor 42, which may comprise one of the PowerPC™ line of processors produced by IBM Corporation, is a general-purpose processor that executes boot code 41 stored within ROM 40 at power-on and thereafter processes data under the control of operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 12 to LAN 10, and graphics adapter 68, which interfaces computer system 12 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 12 further includes Industry Standard Architecture (ISA) bus 62, which is coupled to PCI local bus 50 by ISA bridge 64. Coupled to ISA bus 62 is an input/output (I/O) controller 70, which controls communication between computer system 12 and attached peripheral devices such as a keyboard, mouse, and a disk drive. In addition, I/O controller 70 supports external communication by computer system 12 via serial and parallel ports. A lighting controller 25 couples to the system via I/O controller 70 and controls the electrical power delivered to an array of LEDs located along the back panel of computer system 12 under the control of system processor 42. An RFID controller 21 couples to the system through I/O controller 70 and is capable of energizing and reading industry standard RFID transponders and includes a storage suitable for storing a list of any RFID tags found within its vicinity. The RF ID tags (unique identifiers) are stored within the memory of any number of transponders 29 which according to embodiments of the present invention are embedded in cables and peripherals such as USB cables and mice.

Two fundamental types of RFID technology exist: passive and active. Passive transponders are energized by the RF field provided by the reader (controller 21) and require no other source of power (batteries, etc). These passive transponders “wake up” when they are in-field and respond with a unique tag or identifier. Active transponders, on the other hand, are independently powered (usually battery) and continuously broadcast their identifier (ID). Closely associated with the class of the transponder (passive or active) is the carrier frequency. Tradeoffs exist between range, power, etc when considering active vs. passive implementations. Traditionally, passive transponders are relatively lower frequency (125 kHz, 13 Mhz, 900 Mhz ranges) with subsequent shorter range (for both transmission and power utilization considerations) while active transponders are typically in the 2.45 GHz range. Passive technology usually equates to lower-cost and is prevalent in the scannable asset tagging domain (library books, packaging, etc). Active technology can have significant range and is used for transport ID (freight trains, auto toll collection, pallet level distribution, etc).

In either case, the transponder is used to establish a communication channel with the RF reader, such as RFID controller 21. The RF reader is always the ‘active transmitter’ and serves as the master in the communication sequences. Those skilled in the art are familiar with how to arbitrate and differentiate multiple transponders in-field at a given time and how to establish singular sequential secure communication channels with each. Once a given transponder is ‘selected’ the reader can then communicate via reads or writes with the transponder. Information is aliased onto the base carrier typically using AM schemes. In its simplest implementations RFID may be read only where the transponder simply broadcasts its ID (analogous to a barcode).

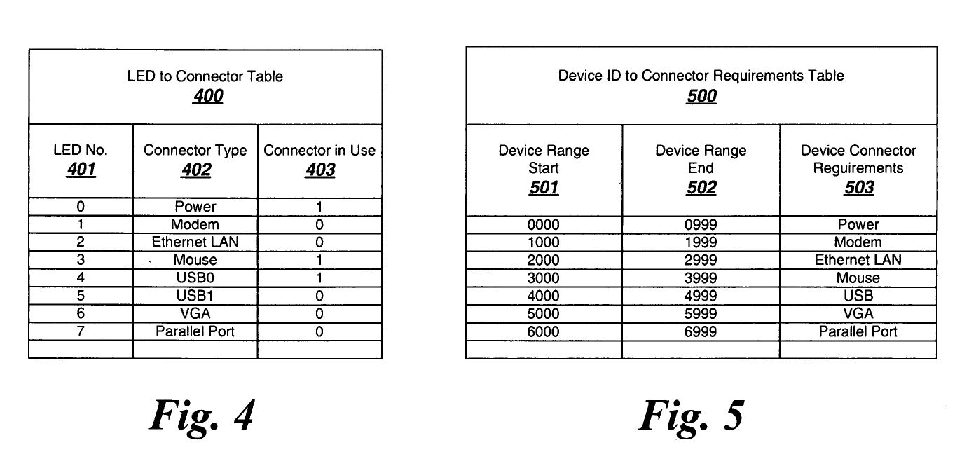

Embodiments of the present invention can encompass any of the above RFID implementations. However, in the embodiment shown in FIG. 4, RFID controller 21 (and each respective transponder) is passive, operates according to the ISO 14443 RFID specification published by the International Standards Organization (which is incorporated herein by reference), and is able to detect the presence of RFID transponders within feet of its proximity. Reader and tag combinations having a shorter range are preferable so as to not pick up inconsequential tags. Thus, a range of two feet is all that is required, while a range of 15 feet is less than optimal. Any found RFID tags for resources are stored in the storage unit of RFID controller 21 as unique identifiers. In addition, when a given transponder 29 is sensed within the vicinity of RFID controller 21, a processor interrupt is generated to inform system processor 42 of the newly detected presence of the particular transponder 29.

The ISO 14443 RFID specification is available in four parts from the International Standards Organization web site which at the time of this writing was located at www.iso.org. The four parts are entitled:
“ISO/IEC 14443-1:2000 Identification cards—Contactless integrated circuit(s) cards—Proximity cards—Part 1: Physical characteristics,”
“ISO/IEC 14443-2:2001 Identification cards—Contactless integrated circuit(s) cards—Proximity cards—Part 2: Radio frequency power and signal interface (available in English only);”
“ISO/IEC 14443-3:2001 Identification cards—Contactless integrated circuit(s) cards—Proximity cards—Part 3: Initialization and anticollision;” and
   “ISO/IEC 14443-4:2001 Identification cards—Contactless integrated circuit(s) cards—Proximity cards—Part 4: Transmission protocol.”

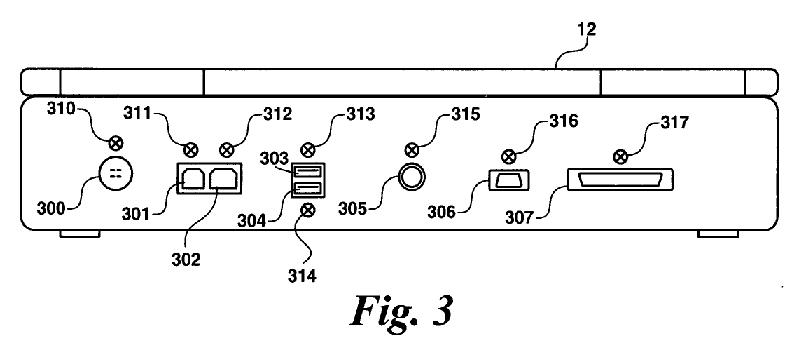

FIG. 3 is a rear elevation view of the personal laptop computer of the preferred embodiment of the present invention. As shown in FIG. 3, computer system 12 includes power connector 300, modem and LAN connectors 301 and 302, a USB header having lower and upper USB port connectors 303 and 304, mouse connector 305, VGA connector 306, and parallel port connector 307. System 12 includes a series of LEDs 310-317 which are used to illuminate the area behind the back panel there shown and to indicate which of LEDs 310-317 correspond to the type of device which a user seeks to connect. As shown in FIG. 3, each of LEDs 310-317 are situated in correspondence to a corresponding one of the connectors 300-307. LEDs 310-317 are controllably energized by lighting controller 25 (depicted in FIG. 2).

FIG. 4 is table of relational data used in accordance with a preferred embodiment of the present invention for correlating LEDs to connector types. Shown there is a relational table 400 having three relational data columns 401, 402, and 403. Column 401 contains an entry for each of the LEDs 310-317 present in the system; these entries are depicted as rows 0 . . . 7. Column 402 contains an entry which indicates the connector type which is positionally related to each of the LEDs entered in column 401. Finally, column 403 contains entries indicating which connectors are presently being used in the system.

FIG. 5 is a table of relational data used in accordance with a preferred embodiment of the present invention for correlating device ID's to connector requirements. Shown for table 500 are relational data columns 501, for indicating the start of a range identifying a particular device, 502, for indicating the end of a range identifying a particular device, and 503, for indicating the type of connector required for each of the ranges defined in columns 501 and 502. When RFID controller 21 detects a proximate cable or device containing a transponder 29, a unique ID is derived from the transponder's response and the connector requirements can be derived from table 500 once the unique ID is found to fall within the ranges defined in columns 501 and 502.

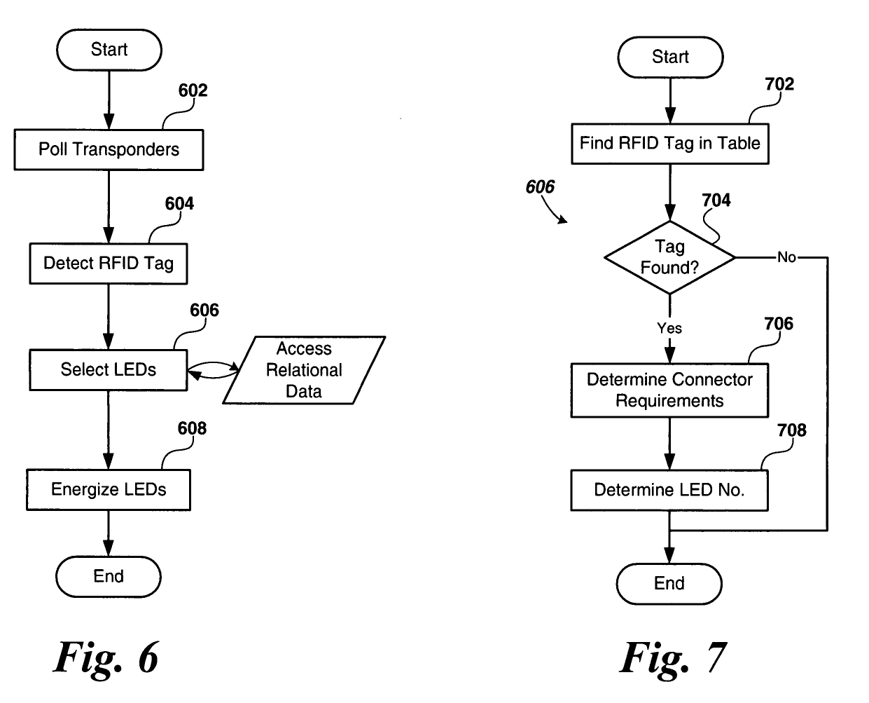

According to the preferred embodiment, while it is only exemplary of this invention, system processor 42 maintains the tables 400 and 500 shown in FIGS. 4 and 5 in system memory 46 while power is applied to the system, and in NVRAM 56 while system power is off. System processor 42 additionally executes the overall logic shown in FIGS. 6 and 7, which are to be described below, to read RFID controller 21 data through I/O controller 70 and pass commands to light controller 25 to energize specific LEDs based on the relational data stored in tables 400 and 500.

FIG. 6 is a flow diagram showing the logic for controlling I/O connector lighting according to a preferred embodiment of the present invention. System processor 42 periodically issues a command for RFID controller 21 to poll 602 for any proximate transponders 29. Alternatively, RFID controller 21 can periodically poll on its own accord and interrupt system processor 42 when necessary in response to the detection. When an RFID tag has been detected 604, RFID controller 21 responds to the polling command by informing system processor 42 of the newly found RFID tag and passes along the RF ID information. System processor 42 then selects 606 which if any of the LEDs are to the energized and passes corresponding commands to lighting controller 25 accordingly. During the selection process 606, system processor 42 accesses the relational data stored in tables 400 and 500 as shall be described with reference to FIG. 7. Finally, lighting controller 25 receives the corresponding commands from system processor 42 and energizes 608 of the LEDs accordingly.

FIG. 7 is a flow diagram showing the logic for controlling I/O connector lighting according to a preferred embodiment of the present invention. FIG. 7 shows in more detail the selection 606 shown in FIG. 6 in which relational data is accessed which correlates RFID tag values to specific ones of the plurality of LEDs 310-317. Initially, system processor 42 references table 500 and attempts to find 702 the device ID by comparing the ID to the relational data found in columns 501 and 502. This comparison is performed by finding which row in the table meets the criteria matching a device ID which is greater than the lower bound of the range specified in 501 and less than the upper bound of the range specified in column 502. If this comparison 704 is unsuccessful, processing ends. However, if this comparison 704 is successful, the connector requirements are determined 706 by reading the entry in column 503 of table 500 corresponding to the successful comparison 704. At this point, the type of connector for which lighting is needed is known. Next, system processor 42 determines 708 which LEDs to distinctively energize by accessing table 400. Knowing the type of connector needing the lighting, column 402 of table 400 is accessed based on this known connector type and the corresponding LED number is selected from column 401. System processor 42 and then update column 403 once the user plugs the device into the connector. Where there are more than one connector available for a given connector type, such as indicated by USB0 and USB1 in table 400, column 403 can be referenced to determine which of the two USB connectors is available. The unavailable connector is then selected for distinction and appropriate lighting. Where both USB connectors are available, both USB LEDs can be selected for distinctive lighting at the same time allowing the user to select which.

While it is only exemplary of this invention, the preferred embodiment energizes a single LED which is closest to the connector which is of the same type indicated by the unique ID and is available or otherwise unused in the system. This is considered the best mode because it conserves power in a battery-powered system. However, other embodiments are envisioned whose scope are covered by the appended claims. For example, in other applications where power savings are not required and where a user can benefit from a general illumination to the entire area behind computer system 12, it may be desirable to energize all of the LEDs 310-317 while providing a distinguishing energization signal to at least one but less than all of LEDs 310-317. E.g., when a USB mouse is brought in proximity to system 12, LED 313 can glow in red while the remainder of the LEDs glow in green. Alternatively, rather than having a distinguishing color, LED 313 can be made to flash, blink, or constantly glow brighter than the other LEDs to give its distinguishing characteristic.

Embodiments of the present invention include various functions, which have been described above. The functions may be performed by hardware components or may be embodied in machine-executable instructions, which may be used to cause a general-purpose or special-purpose processor programmed with the instructions to perform the functions. Alternatively, the functions may be performed by a combination of hardware and software. Although in the preferred embodiment system processor 42 maintains and utilizes tables 400 and 500 and executes the logic shown in FIGS. 6 and 7, the functions there described need not be implemented in the processor 42. In other embodiments, the functions there described can be implemented into I/O controller 70, light controller 25, or into RFID controller 21.

An Embodiment of the present invention may be provided as a computer program product which may include a machine-readable medium having stored thereon instructions which may be used to program a computer (or other electronic devices) to perform a process according to the any of the embodiments of the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media \ machine-readable medium suitable for storing electronic instructions. Moreover, an embodiment of the present invention may also be downloaded as a computer program product, wherein the program may be transferred from a remote computer to a requesting computer by way of data signals embodied in a carrier wave or other propagation medium via a communication link (e.g., a modem or network connection).

In the drawings and specifications there has been set forth a preferred embodiment of the invention and, although specific terms are used, the description thus given uses terminology in a generic and descriptive sense only and not for purposes of limitation.

What is claimed is:

1. Apparatus comprising:
a plurality of light sources each situated in correspondence to a plurality of connectors;
a wireless ID controller which detects an identifier emitted by a proximate wireless ID transponder; and
a light controller coupled to said wireless ID controller and to said plurality of light sources and which selectively energizes said plurality of light sources and provides a distinguishing energization signal to at least one but less than all of said plurality of light sources based on the value of the identifier detected by said wireless ID controller.

2. Apparatus of claim 1 wherein the distinguishing energization signal is effective to energize the at least one light source while a remainder of light sources are turned off.

3. Apparatus of claim 1 wherein a remainder of light sources which are other than the at least one light source are energized and wherein the distinguishing energization signal provided to the at least one light source is a signal selected from the group consisting of a flashing signal and a signal which causes light emission of a color that distinguishes from the remainder of light sources.

4. A method comprising:
detecting an identifier emitted by a proximate wireless ID transponder; and
distinguishably energizing at least one but less than all of a plurality of light sources each situated in correspondence to a plurality of connectors based on the value of the detected identifier.

5. The method of claim 4 wherein the at least one light source is energized while a remainder of light sources are off.

6. The method of claim 4 wherein a remainder of light sources which are other than the at least one light source are energized and wherein a distinguishing energization signal is provided to the at least one light source, wherein the distinguishing energization signal is a signal selected from the group consisting of a flashing signal and a signal which causes light emission of a color that distinguishes from the remainder of light sources.

7. A product comprising:
a computer usable medium having computer readable program code stored therein, the computer readable program code in said product being effective to:
detect an identifier emitted by a proximate wireless ID transponder; and
distinguishably energize at least one but less than all of a plurality of light sources each situated in correspondence to a plurality of connectors based on the value of the detected identifier.

8. The product of claim 7 wherein the at least one light source is energized while a remainder of light sources are off.

9. The product of claim 7 wherein the code is further effective to:
energize a remainder of light sources which are other than the at least one light source; and
provide a distinguishing energization signal to the at least one light source, wherein the distinguishing energization signal is a signal selected from the group consisting of a flashing signal and a signal which causes light emission of a color that distinguishes from the remainder of light sources.

10. Apparatus comprising:
a plurality of connectors;
a plurality of LEDs (light emitting diodes) each situated in correspondence to a corresponding one of said plurality of connectors;
an RFID controller which polls for proximate RFID transponders and detects an RFID tag;
an LED controller coupled to said plurality of LEDs and which controllably energizes said plurality of LEDs; and
a processor coupled to said RFID controller and to said LED controller and which receives the detected RFID tag and passes control commands to said LED controller for selecting which LEDs to energize, the processor being effective to:
access relational data which correlates RFID tag values to specific ones of said plurality of LEDs; and
select which LEDs to energize as a function of the relational data and the value of the received RFID tag, wherein at least one but less than all of said plurality of LEDs are selected for energization.

11. Apparatus of claim 10 wherein said RFID controller polls for proximate RFID transponders and detects the RFID tag by energizing a surrounding area with RF energy and detecting the RFID tag emitted by the proximate RFID transponder.

12. Apparatus of claim 11 wherein the polling is periodic.

13. Apparatus of claim 10 wherein said RFID controller passes the RF ID tag to said processor by generating an interrupt to said processor in response to the detection.

14. Apparatus of claim 10 wherein the relational data includes:
ranges of RFID tag values which are associated with device types having specific connector requirements;
a list of connectors included in said apparatus; and
relational data which associates which LEDs correspond to which connectors.

15. Apparatus of claim 14 wherein the relational data further includes data which indicates which connectors are in use and wherein the selection is further a function of the data which indicates which connectors are in use.

16. A method comprising:
polling for proximate RFID transponders;
detecting an RFID tag;
accessing relational data which correlates RFID tag values to specific ones of a plurality of LEDs (light emitting diodes) each situated in correspondence to a corresponding one of a plurality of connectors;
selecting which LEDs to energize as a function of the relational data and the value of the received RFID tag, wherein at least one but less than all of said plurality of LEDs are selected for energization; and
energizing the selected LEDs.

17. The method of claim 16 wherein said polling for proximate RFID transponders and said detection of the RFID tag is performed by energizing a surrounding area with RF energy and detecting the RFID tag emitted by the proximate RFID transponder.

18. The method of claim 17 wherein the polling is periodic.

19. The method of claim 16 wherein the relational data includes:
ranges of RFID tag values which are associated with device types having specific connector requirements;
a list of connectors included in said apparatus; and
relational data which associates which LEDs correspond to which connectors.

20. The method of claim 19 wherein the relational data further includes data which indicates which connectors are in use and wherein the selection is further a function of the data which indicates which connectors are in use.

21. A product comprising:
a computer usable medium having computer readable program code stored therein, the computer readable program code in said product being effective to:
poll for proximate RFID transponders;
detect an RFID tag;
access relational data which correlates RFID tag values to specific ones of a plurality of LEDs (light emitting diodes) each situated in correspondence to a corresponding one of a plurality of connectors;
select which LEDs to energize as a function of the relational data and the value of the received RFID tag, wherein at least one but less than all of the plurality of LEDs are selected for energization; and
energize the selected LEDs.
